(19) United States
(12) Patent Application Publication
(10) Pub. No.: US 2026/0330502 A1
(43) Pub. Date: Oct. 22, 2026

(54) COMPUTER-IMPLEMENTED METHOD FOR TRIGGERING A FUNCTION

(71) Applicants: VusionGroup SA, Nanterre (FR); VusionGroup GmbH, Fernitz-Mellach (AT)

(72) Inventor: Andreas RÖSSL, Fernitz-Mellach (AT)

(73) Assignees: VusionGroup SA, Nanterre (FR); VusionGroup GmbH, Fernitz-Mellach (AT)

(21) Appl. No.: 19/103,465

(22) PCT Filed: Oct. 7, 2022
(86) PCT No.: PCT/EP2022/077997

§ 371 Date: Feb. 12, 2025

(51) Int. Cl. G06Q 30/0251; G06Q 30/02; G06Q 30/0211; H04W 4/021

(52) U.S. Cl. CPC G06Q 30/0261; G06Q 30/0211; G06Q 30/0271; G06Q 30/0281; H04W 4/021

(57) ABSTRACT

A computer-implemented method for triggering a function, the method comprising the following steps: radio-based determination that a mobile user device is located at least in the surroundings of a sales area, checking whether representation data are available that represent advertising, in particular relating to the sales area and/or relating to a product offered in particular with respect to the sales area, which advertising was transmitted via the Internet to the user device itself or to another device linked to the user device, and automatic triggering of at least one function that corresponds to the representation data.

### TECHNICAL FIELD

The invention relates to a computer-implemented method for triggering a function

### BACKGROUND

Nowadays, the display of Internet-based content on a user device is often accompanied by providing advertising, which is also displayed on the user device as additional information that is associated with the content of the Internet-based content, where it can be perceived by the user as an incentive to purchase products or services. Against this background, the object of the invention is to increase the benefit of this additional information, i.e., advertising, above that of pure purchasing incentive

### SUMMARY OF THE INVENTION

This task is solved by means a computer-implemented method according to claim 1. The object of the invention is therefore a computer-implemented method for triggering a function, wherein the method comprises the following steps, namely: radio-based determination that a mobile user device is positioned at least in the vicinity of a sales area; checking whether representation data are available that represent advertising, in particular, relating to the sales area and/or relating to a product offered, in particular, with regard to the sales area, which advertising was transmitted via the Internet to the user device itself or to another device linked to the user device, and automatic triggering of at least one function that corresponds to the representation data.

The measures according to the invention are accompanied by the advantage that displaying the advertisement on the user device or the other device linked to it can be used for the later fully automatic triggering of the function as soon as the user device is at least in the vicinity of the sales area. Thus, a location-dependent automatic triggering of the function is possible, wherein the location dependence results from the current location of the user device that carries the user device with it. The function itself can be diverse, wherein it is a technical function, i.e., a function that is carried out on a technical device, in particular, a controlling or communicating function.

The sales area can be understood as, for example, the outdoor sales area of a market, the interior of a supermarket building, or even a small shop in a street, etc., i.e., in general, a business premises or the area in the business premises where products are presented for sale.

The area around the sales area can be understood to mean, for example, a parking lot, a parking garage, a street intersection or a sidewalk, etc., in the immediate vicinity of the sales area.

The mobile user device can be understood as a smartphone, a tablet computer, an intelligent watch (smart watch) or even a portable tracking device (such as an Air Tag launched onto the market by Apple), etc.

Representation data can be understood as a digital image of the advertisement, such as plain text information contained in the advertisement or forming the advertisement, or plain text information describing the advertisement, or also image information reduced to the essence of the advertisement and/or also such audio information describing the advertisement. However, it can also be information encoding the advertisement in accordance with a coding scheme that cannot be decoded without knowledge of a decoding scheme. This allows the content of the advertisement to be anonymized. It can also be data that provides a link through which the advertising provided or metadata, i.e., data describing the content of the advertisement, regarding the advertising can be retrieved. So-called cookies can also be used in connection with the representation data, which are stored on the user device as a result of the display of Internet-based content and make the representation data available there. In order to interpret the content of the representation data, it can be automatically analysed to determine whether it contains plain text information, e.g., the name of the sales area (i.e., the respective shop/supermarket name, etc.) or whether it contains image information that can be used to draw conclusions about the location or name of the sales area by means of digital image evaluation, or whether it contains a link so that the link refers to the location or the name of the sales area can be inferred or this information can be obtained, etc. The same applies mutatis mutandis to the product. The representation data can also indicate a combination of sales area and product in the form mentioned. In this way, computerized representation data can be used to draw conclusions about a specific sales area, a specific product or both.

The advertisements are usually delivered from a computer other than the user device through a communication network, in particular, the Internet, to the user device or the device linked to it.

In the sense of a broad interpretation, the product is to be understood as both a good as well as a service that is offered and which can be rented, leased or purchased. The formulation “ . . . advertising . . . and/or concerning a product offered, in particular, in relation to the sales area, . . . ” is to be understood in such a way that it can initially be an advertisement for a product without directly referring to a sales area. However, in a narrower interpretation, it is advertising for a product with a connection to the sales area. This can be a product that is actually located in the sales area or also a product that is only offered there but does not have to be physically available there because, for example, it is currently out of stock.

Further, particularly favourable embodiments and further embodiments of the invention result from the dependent claims as well as the following description.

The computer can be a single device, a server farm, a cloud-based service such as a video platform (such as YouTube, Vimeo, etc.), a search engine for searching content on the Internet (such as Google, Bing, Yahoo, Baidu, Yandex, etc.), or similar, wherein the cloud-based service can be centrally organized or decentralized on a server farm. The term computer is therefore to be understood as a synonym for the entities or services mentioned and is not to be interpreted only in the narrow sense of the word as a single device. Furthermore, the computer is therefore not the data processing system used by the operator of the business unit for its commercial purposes, its product logistics or also its control of devices in the sales area, although this data processing system can also be organized in a decentralized or cloud-based manner.

The advertising, on the other hand, originally comes from an advertiser or, in essence, refers to it or its products. Advertisers can be companies, entities and persons who advertise their products or the products they only sell for themselves or commission advertising for them. This can be the operator of a business who manages the business area directly. However, this can also be a producer of a product or a service provider who advertises its goods or services directly, although these goods or services are available in the sales area of a third party (the shop operator). The sales area is therefore operated by another natural person or legal entity who is different from the producer or service provider. Advertising agencies are often used for the operational implementation of advertising, which design the content of the advertising and implement the media implementation, wherein the advertising is ultimately made available on the Internet via the computer and is placed there in the context of the content retrieved.

Being particularly preferred, during the course of determining that the mobile user device is positioned at least in the vicinity of the sales area, identification data (a user device ID; a user ID) are captured, which identification data relates to the user device or the user of the user device or the relationship between the user and identify the user device. This means that for further data processing or communication, in particular, for the automatic triggering Of the function, a unique identification of either the user (via the user device in question) or only the user device or both can be used. The function can therefore be triggered in a targeted manner in the context of the respective user or his/her user device. For subsequent use, the representation data can also comprise the identification data to identify the user device on which the advertisement was displayed or the user to whom the advertisement was displayed, or to establish a connection between the displayed advertisement on the one hand and the user device or user on the other hand. However, this connection can also take place across user devices, as a user can, for example, sit at home at his/her personal computer (PC) and consume Internet-based content while advertising is displayed, whereas he/she can move around the store, i.e., the sales area, to shop with his/her smartphone or smartwatch. In this typical scenario, the representation data can first be created on the PE and then delivered to the user's other user devices. This can be done in direct communication between the various user devices or via a cloud-based service in which all of the user's user devices involved are registered, i.e., linked to each other. However, the representation data can also be stored in a separate cloud-based service and made available centrally for further use.

In accordance with one aspect of the invention, it can be provided that the automatic triggering of the function comprises at least one of the following activities, namely: a logging of the proximity that has occurred, an automated transmission of an electronic message to the mobile user device, an automatic transmission of an electronic message to a data processing system assigned to the operator of the sales area, wherein the logging of the and/or the automatic transmission of the electronic message represents a single event of the proximity that has arisen or forms a representation of such individual events.

Logging can be done in a log file, for example. The log file can be created on the computer, user device, or data processing system and then stored there. However, the log file can also be created on one of the mentioned entities and stored on another, depending on the further processing scenario.

Individual events can be logged for the occurrence of the proximity and can also be processed or forwarded immediately. The occurrence of a plurality of such proximities can also be captured across time spans with the aid of the log file and can be used for further utilization or forwarding after the time span has elapsed.

In accordance with a first embodiment, the further processing of the proximities that have arisen can be carried out with the aid of the mobile user device to which the log file was forwarded or where it was also created.

In accordance with a second embodiment, further processing can also be carried out with the aid of the data processing system of the operator of the sales area where the log file was created or to which it was transmitted.

In accordance with a third embodiment, the evaluation of the log file can also be carried out with the aid of an Internet-based service (e. g., with the aid of an Internet-based search engine), which was also responsible for providing advertising, for example.

What these three embodiments have in common is that the present log file can be used to analyse the advertising strategy. This can be done in the case of immediate processing or processing of the log file almost in real time at the occurrence of the respective proximity or at a later point in time in order to be able to analyse a larger database regarding the occurrence of the proximities. In particular, real-time processing is associated with the advantage that it is possible to react as quickly as possible to the occurrence of the proximity, and where applicable, special offers can even be made available “just in time”. The way in which offers are involved can be dynamically adapted to the respective proximity or to the original underlying advertising. If, in contrast, a plurality of neighbourhood events are evaluated together, i.e., after the time span in which they occur has elapsed, this can lead to an accurate statement about the advertising effect.

In accordance with a further aspect of the invention, it can be provided that the automatic triggering of at least one function that corresponds to the representation data entails that, with the aid of a database which database stores the product position for products in the sales area with the aid of product position data, the representation data are linked to the product position data for the product affected by the representation data. This measure forms the basis for further technical support measures that can lead to a purchase of the product. The link subsequently allows a more precise indication of the distance or route to the place where the product in question, which was advertised with the aid of the advertisement, can actually be obtained. For example, a comparative scenario can be provided or displayed for the user, in which not only different prices from different markets are compared for a product, but also the actual distances measured from the user's current location to the product in question between the markets in which the product is offered are compared. The one-dimensionality of the originally transmitted advertising is thus fanned out multidimensionally and thus forms a more meaningful basis for decision-making for the user, who is now provided access to not only to the advertising but also to the product positions linked to it or parameters that can be derived therefrom, such as distance to the product/market or also the travel time to the product/market. The same can also be done at the market level, i.e., at the level of the sales area, where prices, route lengths or also procurement times for advertised products of a comparable type advertised by the advertising are made comparable for the user of the mobile user device, i.e., for a potential customer.

In accordance with a further aspect of the invention, it can be provided that the automatic triggering of at least one function that corresponds to the representation data entails that a discount is automatically provided for automatic use for the product advertised by the advertisement. This discount can be applied automatically when purchasing the product in question, i.e., without requiring further consultation with the user or any further action by the user. Then again, this discount can only be used for the purchase if the user takes a further action, for example scanning a confirmation code with his/her user device or interacting in an interface on his/her user device or performing a manual or radio or digital interaction on another device, such as a cash register terminal or an electronic display device.

In accordance with a further aspect of the invention, it can be provided that the automatic triggering of at least one function that corresponds to the representation data comprises purchase confirmation data automatically generated as a result of the purchase of the product in the sales area, wherein the purchase confirmation data document a relationship between the advertisement and the purchased product, and the purchase confirmation data are provided for further processing. This connection ensures that those purchases that are related to the advertising provided remain distinguishable from other purchases made without reference to the advertising, i.e., that they can be treated differently in the further data processing, namely in different entities that extend from providing the advertising via the mobile user device to the data processing system assigned to the sales area.

In accordance with a first embodiment type of the invention, radio-based determination is based on the fact that position data, which position data represent the position of the mobile user device, are received by radio from the computer available via the Internet, and it is determined there that the mobile user device is at least in the vicinity of the sales area or, in other words, in the vicinity of the sales area, wherein the location of the sales area is known to the computer, but the computer is not assigned to the sales area or its operator.

The position data can represent GPS coordinates, which are determined, for example, with the aid of a GPS receiver in the mobile user device and are then transmitted from the mobile user device to the computer via radio (via an Internet connection, such as an LTE1 3G1 4G1 5G connection or a WLAN connection). However, the position data can also be determined by a mobile phone operator. The mobile user device can determine the presence of the mobile user device that is logged into its mobile network and its position with the aid of the radio cells of the mobile network, e.g., by means of triangulation or other measures, and transmit the position determined (or approximated), either to the mobile user device, from where this position is transmitted to the computer by radio as discussed, or directly to the computer via the mobile network, thereby specifying which user device is involved, i.e., using the user-device ID or user ID.

Since the computer has the position of the sales area, e. g., because it has stored this position in a digital (country) map or it can access such a digital (country) map, with the aid of the received position data, the computer can determine that the mobile user device, if carried by the user, is in the vicinity of the sales area.

The measures listed here for the radio-based determination of the existence of a proximity therefore do not require a direct radio connection between the mobile user device and a radio infrastructure of the sales area or the operator of the sales area.

In accordance with a second embodiment type of the invention, radio-based determination is based on the fact that the mobile user device has entered a radio range, which radio range is covered by a radio device assigned to the sales area.

The radio device can be a WLAN radio device, or a MESH radio device based on WLAN technology. A ZigBee radio device, a Bluetooth radio device, etc. can also be used. Furthermore, it can also be a proprietary radio device.

The radio device can be implemented, for example, by means of a radio transceiver that is designed for bidirectional radio communication with the user device in order to enable the radio-based determination that the mobile user device has entered a radio range. Similarly, only a radio transmitter that is only used to transmit a radio signal for radio-based determination on the side of the user device that the mobile user device has entered the radio transmission range of the transmitter can also be used. Similarly, only a radio receiver which is intended only for receiving a radio signal transmitted by the user device can also be provided for the purpose of radio-based determination that the mobile user device has entered the radio reception area of the receiver.

A single radio device can be used, for example, if the essentially entire sales area can be completely covered by the radio range of the only radio device or if only one sub-area in the sales area is to be assigned to the radio range of the radio device.

A plurality of radio device can be used, for example, if the entire radio range spanned with their aid is to extend over a spacious sales area or if sub-areas of the sales area are to be covered by individual radio ranges.

In the present case, the phrase “. . . that the mobile user device has entered a radio range . . . ” can be understood in such a way that the radio range also extends slightly beyond the physical boundary of the sales area, because the radio signal generated in the sales area does not disappear abruptly with the physical boundary of the sales area. The specification that “. . . the radio device is assigned to the sales area, . . . ” means that the radio device is essentially at the disposal of the operator of the sales area, is installed in the sales area, and/or interacts with the rest of the electronic infrastructure of the sales area or can be controlled via it or can transmit data to it.

The entry into the radio range determined in this way, which is defined by a radio device assigned to the sales area, forms the basis for the automatic triggering of a function within the sales area in a targeted manner.

If the function is to be triggered automatically by the data processing system, it is favourable if the captured identification data are transmitted to the data processing system assigned to the sales area or the operator of the sales area.

The data processing system is preferably a part of the electronic infrastructure of the sales area or forms the electronic data processing infrastructure of the sales area, which uses the identification data for further processing.

In accordance with a further aspect, the check is carried out via the data processing system on whether the representation data are available so that the data processing system can also automatically trigger the function that corresponds to the representation data when the representation data are available. In summary, it can therefore be stated that not only the radio-based determination but also the automatic triggering of the function takes place within the sales area, i.e., an autonomous reaction can take place in the sales area to the mobile user device entering the radio range as well as to the representation data being available.

In accordance with a first variant of the second embodiment type, it can be provided that the data processing system contacts the user device via the radio device in order to check whether the representation data are available and obtains the representation data from the user device, thereby further processing this representation data. Favourably, this first variant enables direct further processing of the representation data without requiring further involvement of the mobile user device or even the computer available via the Internet. In this case, the further processing of the representation data can be carried out completely autonomously by the data processing system, in particular, in real time for obtaining the representation data from the mobile user device.

In accordance with a second variant of the second embodiment type, it can be provided that the data processing system, initially receives a data record comprising the identification data and related representation data from a computer other than the user device or the other device linked to it, which is not assigned to the sales area or its operator, in particular, via the Internet, and saves it for subsequent processing and uses it as a result of the of the detected entry of the user device into the radio range of the radio device, checks whether a data record with the identification data that was also transmitted when the user device entered the radio range has been stored and, in the event of a positive test result, further processes the representation data of the data record. In this case, there is also a fundamentally autonomous processing of the representation data by the data processing system. In this case, only communication with the data processing system is required, wherein the representation data, on the one hand, and the identification data of the mobile user device in question, on the other hand, are made accessible. However, the representation data, together with the identification data, which indicate to which user device the advertising was previously transmitted, must be received by the data processing system from the computer available via the Internet in advance, i.e., in time before the mobile user device enters the radio range, and must be temporarily stored for later verification. Only after one or a plurality of data records have been stored can a check be carried out as a result of the entry of a mobile user device into the radio range assigned to the sales area, whether a data record is available for the mobile user device in question, the representation data of which can be used.

In accordance with a third variant of the second embodiment type, it can be provided that the user device communicates the entry into the radio range to a computer that is not assigned to the sales area or its operator and which stores the representation data provided for the user device, in particular, via the Internet, and that this computer transmits a data record comprising the identification data and related representation data belong to the user device communicating the entry into the radio range, to the data processing device, and the data processing device checks whether a data record with identical identification data has been received relating to the identification data of the user device entering the radio range and, in the event of a positive test result, further processes the representation data of the data record. In contrast to the second variant, the third variant requires the mobile user device to first carry out two acts of communication essentially in real time when entering the radio range assigned to the sales area. Namely, on the one hand, the mobile user device must identify itself to the data processing system by means of its identification data where these identification data are stored, and on the other hand, it must contact the computer available via the Internet with its identification data, thereby indicating the identification (address) of the data processing system so that the computer can send the data record to the data processing system in a further addressed act of communication. In this case, two different acts of communication are also required from the side of the data processing system, namely the one in which the identification data are received from the mobile user device and the one in which the data record is received by the computer. Only then can the data processing system check whether there is a data record belonging to the previously identified user device, according to which its representation data are used in the event of a positive test result.

The representation data now available in the data processing system—regardless of the selected variant—is evaluated by the data processing system and one or a plurality of preset functions are triggered depending on the representation data. The automatic triggering of the function can be, for example, radio-based communication with the mobile user device, wherein, for example, the aforementioned discount for a purchase is preset, i.e., saved. This process does not necessarily have to be immediately transparent for the user. Rather, the discount can be reserved for a later purchase action and the use of the discount can only become transparent to the user during the course of the purchase transaction.

In accordance with another aspect, the automatic triggering of the function can be a human-perceptible reproduction/playback that comprises one of the following forms of reproduction/playback, namely: a light-signal reproduction, a text reproduction, an audio playback, an image reproduction and/or a video playback.

For this purpose, the mobile user device can independently trigger and carry out the human-perceptible reproduction/playback as a result of the entry into the radio range independently determined by the mobile user device, in particular, directly.

Likewise, the function on the mobile user device can be triggered by the computer, which is or has been informed of the fact that it has entered the radio range. This notification can be made by the mobile user device itself or by the data processing system.

Furthermore, a device assigned to the sales area and/or the mobile user device can be controlled for human reproduction/playback with the aid of the data processing system.

In accordance with a special aspect, the content of the human-perceptible reproduction/playback can be determined by the representation data. For example, a text, an acoustically perceptible announcement, a still image or even a video can be reproduced from the representation data or related to the representation data via a device designed for the respective reproduction/playback. This device can be, for example, a screen in the sales area, which is positioned in the entrance area of a supermarket, for example, and there, based on the representation data, displays information directed at the originally received advertisement or the advertised product. This can remind the user of the advertised product, thereby creating a purchasing incentive. Furthermore, smaller display devices, such as electronic labels, for example, in particular, electronic shelf labels, can also be used for this type of visually perceptible reproduction/playback. They are particularly suitable for the reproduction/playback of essentially static content, which is usually given by text and/or a still image. Furthermore, so-called video shelving rails can also be used, which are installed on the front of a shelf and are used for the playback of videos. This device can also be a loudspeaker system of a supermarket, where an announcement that is tailored to the original advertisement or the advertised product, preferably automatically generated, is played.

In order to provide information addressed to the user of the mobile user device, and to do so accurately even if this user moves around the sales area at will, it has proven to be particularly favourable that the human reproduction/playback is triggered on the user device.

However, in order to provide information addressed to the user of the mobile user device, which is, in particular, location-bound, it has proven to be favourable that the human-perceptible reproduction/playback is triggered on an electronic display device, such as an LCD panel, flat screen, etc., in particular, on an electronic shelf label for example. This enables a targeted initiation of attention to the location where the electronic display device is located, wherein the product, which is usually positioned there, also moves into the user's area of attention of the mobile user device.

It should be mentioned at this point that the human-perceptible reproduction/playback can also be combined, i. e., both on the mobile user device and on the electronic display device.

It has proven to be particularly favourable if the automatic triggering of the human-perceptible reproduction/playback is selectively carried out only for those electronic display device(s) whose content is or is affected by the representation data or by the advertising represented with the aid of the representation data. This measure allows the very electronic display device belonging to the product for which the advertisement was placed to be selected selectively in relation to the entirety of the electronic display devices for human reproduction/playback. For example, the advertising placed can be specifically referred to in the location of the advertised product, i.e., reminded of it. In the context of the advertising placed, a plurality of such display devices can of course also be affected if the advertising refers to a group of products or to a class of products. The selection of the electronic display device(s) in question is made with the aid of the aforementioned database, which stores the product positions within the sales area. This database can also store the electronic display devices linked to the respective products (more precisely, their identity or address) so that the advertising or the representation data in the database can be used to retrieve the product concerned and, subsequently, also the associated electronic display device. The control of the electronic display device with the provided human-perceptible reproduction/playback is then carried out via the data processing system—where applicable with the involvement of a radio network in the sales area—in a sufficiently familiar way.

Particularly preferred is the automatic triggering of the human-perceptible reproduction/playback depending on the position of the user device in the sales area. This is accompanied by the advantage that, on the one hand, energy-saving operation of the electronic display devices is ensured, as they are often battery-operated and thereby, a situation in which they would have to flash continuously, for example, is avoided. Furthermore, it can be ensured that the human-perceptible reproduction/playback only actually takes place when the user device in question is located in an area in which it can be assumed that the user can actually perceive the human-perceptible reproduction/playback. The limitation of the area within which the presentation of the human-perceptible reproduction/playback is to take place can be realized, for example, by evaluating radio signals. For example, switching the user device from one radio range to an adjacent radio range within the sales area can be used to activate human-perceptible reproduction/playback. In this context, it should be mentioned as an example that a first radio range covers, for example, the entrance area of a supermarket, where a relatively large flat screen is installed that reproduces advertising identified by the representation data. In this context, it should also be mentioned as an example that a second radio range covers a shelf aisle, where a smaller flat screen is installed on the entrance side, which plays advertising identified by the representation data. Depending on the presence of the mobile user device in the first or second radio range, the larger or smaller flat screen is used and presents selective information to the relevant user of the mobile user device. However, this exemplary system can even be reduced to the level of shelves or shelving rails, where the electronic display devices are selectively used in groups or individually to present the human-perceptible reproduction/playback. This only requires that the radio signals used to limit the position of the user device be evaluated with a corresponding position reference to the electronic display devices to be activated or deactivated or also to be controlled in a situation-specific manner.

In this context, it has proven to be particularly favourable to use a Bluetooth beacon to decide whether a distance threshold value between the electronic display device and the user device has been fallen short of, which serves as a criterion for triggering the human-perceptible reproduction/playback.

For example, the signal strength or an RSSI value, wherein RSSI stands for Received Signal Strength Indication, which is determined in a radio device or radio device during the course of radio signal processing, can be used to estimate the distance between the mobile user device on the one hand and, on the other hand, the electronic display device on the other, and, if the distance threshold value is not reached, the electronic display device in question can be used to present the humanly perceptible reproduction/playback.

The RSSI value can be evaluated in the mobile user device, where the exceedance of distance threshold value is detected, and this circumstance is communicated in the radio network of the sales area so that the relevant electronic display device is controlled via the data processing system. For this purpose, the Bluetooth beacon can be installed at any point within the sales area. Preferably, however, a plurality of Bluetooth beacons are positioned in different places in the sales area and send individual beacon radio signals from there, which clearly identify them. These different positions can denote, for example, business areas, aisles, individual shelves or even shelf compartments or shelving rails. It can also be provided that the electronic display devices themselves have the Bluetooth beacons, which further increases the spatial resolution in the sales area.

From the mobile user device receiving the beacon radio signal(s), the ID of the Bluetooth radio signal used for distance determination is subsequently also transmitted to the data processing device, which results in spatial information regarding the position of the mobile user device, with the aid of which it can be determined whether the mobile user device in question is located in the vicinity of the electronic display device that is used due to the representation data for human-perceptible reproduction/playback.

Similarly, it can also be provided that the mobile user device contains a beacon/in particular, a Bluetooth beacon whose beacon radio signal can be received by receivers distributed in the sales area so that the distance to these receivers can be determined or the distance to the mobile user device can be determined. The positions of the aforementioned receivers can be selected as well as those of the aforementioned Bluetooth beacons, in particular, integrated into the electronic displays. This allows distance determinations to be broken down to the level of the distance between the mobile user device and the electronic display devices. and in the most energy-efficient way possible. The rechargeable batteries of mobile user devices can be easily charged by their users themselves as often as necessary, whereby the energy required to transmit the beacon radio signal is deemed inconsequential. At the same time, however, in the case of battery-powered electronic display devices, the receive mode for receiving the beacon radio signal requires only a relatively small amount of energy compared to what would be required for a transmitting operation to transmit the beacon radio signal.

Regardless of how the distance is determined, it has been found to be extremely favourable if the electronic display device comprises at least one light-emitting diode (LED) that is controlled for flashing light-signal reproduction. LEDs can be operated in a very energy-saving way, which also has a positive effect on battery life, analogous to the case of battery-operated electronic display devices discussed in the previous paragraph. In addition, light sources emitting light in point-specific manner are extremely easy for the human eye to perceive and the associated human orientation. They therefore attract the desired attention to the user of the mobile user device with as little effort as possible and visually direct him to the product that was advertised by the advertising previously displayed on his/her user device. In particular, it is no longer necessary for the user to cognitively process textual or pictorial information that is perceptible to humans, which could distract him/her from the perception of the advertised goods or services or could even be perceived as disturbing by him/her.

In addition to directly displaying the product, which is located in the immediate vicinity of the user device so that it can be visually perceived by the user, the human perception can be used to navigate to the position in the sales area provided for the product affected by the advertisement. The user can therefore also be directed over a further distance, from where he/she will not initially be able to see the advertised product, to the area of the sales area from which he/she can see the advertised product or from where he/she can be made aware of the product in question by applying the measures stated in the preceding paragraph.

Since the data processing system knows the positions of the product in the sales area and also knows their associated electronic display devices, the data processing system can plan a route to the product or service in question as soon as it enters the radio range after the transmission of the representation data or using the representation data for the mobile user device in question. This route can now be made accessible to the mobile user device in question in the sales area in a human-perceptible way using the aforementioned technical visualization devices, such as the flat screens and, in particular, the plurality of electronic display devices for example. It can also be provided that the screen and/or the audio output device of the mobile user device is used for navigation, wherein the aforementioned measures using a beacon radio signal are again used to locate the mobile user device. In this way, navigation information can be provided or displayed dynamically in the sales area, i.e., in particular, location-dependent, which is determined by the representation data.

In order to make it possible to ascertain the success of the advertising provided, it is favourable, in accordance with another aspect, if, after the mobile user device has entered the radio range assigned to the sales area, the mobile user device and/or the data processing system assigned to the sales area check whether the representation data are related to the sales area. This measure makes it possible to process and interpret the behaviour of the user using the mobile user device, i.e., the potential customer, in the context of the provided advertising. The success of an advertisement can thus be determined.

In accordance with another aspect, it has proven to be favourable if the reference to the sales area is established by the representation data showing the sales area as such as advertised.

For example, the representation data indicates that the advertisement concerns a specific supermarket or supermarket chain. If the mobile user device now enters the radio range of the sales area of the supermarket in question, it is determined that the corresponding advertising has been consumed with the user device or with a device linked to the user device, which is determined by the representation data. Furthermore, it is possible to record how many people enter the sales area in total. This can also be done, for example, with the measures mentioned above or with measures that deviate from them, such as a visitor counting system that is not based on radio signals for example. Thus, the success of the advertising can be determined. In particular, it can be used to determine the proportion of visitors to the sales area who received the corresponding advertisement, i.e., what effect the advertising has on the number of visitors or the proportion of visitors in question.

In accordance with another aspect, it has proven to be favourable if the reference to the sales area is established by the representation data showing a product offered in the sales area as advertised.

With the aid of the available representation data, it can be checked whether the product advertised by the representation data is actually offered in the portfolio of the business concerned. The aforementioned database, which lists the products, can serve as a basis for this. This aspect can cover two situations, i.e., first, the situation in which the product is actually available in the sales area, or second, the situation in which the product is offered in principle in the sales area but is currently out of stock. This measure therefore makes it possible to check whether the visit to the sales area could have taken place because the product, which is in principle in the sales area, was advertised via the advertising placed.

These measures therefore make it possible, regardless of whether the reference to the sales area concerns the sales area as such or a product offered therein, to make the success of advertising ascertainable and, where applicable, even measurable. For this purpose, it has proven to be favourable that the mobile user device and/or the advertising data processing system generates advertising success data if there is a established connection to the sales area—i.e., to the sales area as such or to the product offered in the sales area.

In principle, the advertising success data can be generated exclusively by the mobile user device or exclusively by the data processing system and can be made available by the respective entity for further processing.

However, the advertising success data can also be generated by the user device and the data processing system for one and the same occurrence. This creates redundancy that counteracts data loss or data manipulation, because the advertising success data are generated both on the customer's side, i.e., on the part of the mobile user device, as well as on the seller's side, i.e., on the part of the data processing system, which are then subsequently made available by the respective entity for further processing and can be compared with each other in order to provide support for the occurrence at hand.

The advertising success data essentially represents, as mentioned that the visit to a sales area is due to an advertisement previously presented to the user. Specifically, the advertising success data can comprise the representation data or a reference to it and the identification data as well as at least an indication identifying the sales area in which the reference to the sales area was established. On the one hand, this triplet of data enables the computer responsible for showing the advertisement to determine that the advertisement placed has achieved the desired success, such as the user's presence in the sales area for example. In a broader sense, this serves as the basis for calculating a “conversion rate”, which indicates/how effective the advertising actually was. On the other hand, however, this triplet of data also enables the computer responsible for showing the advertisement to determine/in which of the sales areas the effect of the advertisement has occurred/and thus forms the basis for a business model take account of the effectiveness of the advertisement.

However, the topic discussed above can also be further refined. In accordance with this refinement of the topic at hand, it can be provided that the advertising success data will be generated when a distance between the mobile user device and the advertised product determined on the basis of at least one radio signal—which can be the beacon radio signal mentioned above—determined in accordance with the preceding discussions, has fallen below a distance threshold value. In this case, the mentioned sub-areas in the sales area can be marked by different beacon radio signals and individual products or product groups can be assigned to individual radio ranges of these beacon radio signals. However, in accordance with a preferred embodiment type, electronic display devices are used here, which, in turn, transmit beacon radio signals, which are then evaluated by the mobile user device, or receive and evaluate beacon radio signals transmitted by the mobile user device.

The advertising success data generated on the basis of the distance threshold value can replace or supplement previously generated advertising success data generated by the determination of presence in the sales area to an advertising-success-data group. This means that graduated as well as more precise statements about advertising success can be made and, where applicable, incorporated into the business model.

In accordance with another aspect, it can also be provided that the advertising success data are generated if an electronic interaction has taken place between the mobile user device and the electronic display device assigned to the advertised product or an interaction device—such as a checkout terminal—preferably an electronic interaction has taken place at the end of a purchase, in particular, the electronic interaction as a near-field-communication-based (NFC for short) interaction has taken place.

Near-field communication refers to a technology that is known, for example, in the context of the ISO/IEC 14443 or ISO/IEC 15693 standard.

That measure makes it possible to further clarify the answer to the question whether an advertisement has had the desired effect, namely, in the present context, the effect of posting the product for the subsequent purchase or even the purchase as such. As discussed earlier, the interaction-triggered advertising success data can replace the previously generated (or explained) advertising success data or complement the advertising-success-data group. In this case, the advertising success data can be the purchase confirmation data discussed above, or the advertising success data can comprise the purchase confirmation data or a reference to the purchase confirmation data.

The advertising success data generated in this way are transmitted via a computer network, in particular, the Internet, from the mobile user device or the data processing system to the computer from which the advertising was provided and which is not assigned to the sales area or its operator. This forms the basis for a wide variety of optimization measures regarding the provision of advertising as well as its content on the computer side as well as, where applicable, taking account of the advertising measures to be carried out, taking into account the effect of the advertising indicated by the advertising success data. For example, the billing model can be differentiated in such a way that users of the mobile user device simply visited a shop, i.e., were present there, which can have an effect on the generation of sales regardless of the advertised product. However, the billing model can also differentiate in such a way that the user moved in the sales area close to the advertised product, did not buy it for unspecified reasons, but his/her presence in the vicinity of the product can have led to sales in relation to neighbouring products. Ultimately, the billing model can also differentiate in such a way that actual purchases of products that have been specifically advertised are taken into account.

In order to ascertain a further depth in the value chain, it can also be provided that, apart from the aforementioned circumstances that lead to the generation of the advertising success data, the registration of a purchased product with a manufacturer of the product or a service partner of the manufacturer or the distributor of the product, which is usually done via the manufacturer's the distributor's website, also leads to the generation of the advertising success data. This registration process can be carried out, for example, via the mobile user device or the other device linked to it, or also directly in the shop with the aid of the shop's data processing system, since—depending on the implementation of the method according to the invention—the representation data are available for the respective entity to be used. As part of the registration process, the representation data together with the identification data can also be transferred to the data processing device contacted via the Internet for registration so that the advertising success data can be generated there. This measure can also be included in the optimization and/or billing model mentioned in the previous paragraph, because now, the conversion rate can also comprise the market participants involved in the registration of the product.

Ultimately, it should be b mentioned in general that the electronic devices discussed (ESLS, smartphone, tablet computer, video shelving rail, etc.) naturally comprise electronics. The electronics can be discrete or integrated electronics, or also a combination of both. Microcomputers, micro-controllers, application-specific integrated circuits (ASICs), possibly in combination with analogue or digital electronic peripherals, can also be used. Many of the mentioned functionalities of the devices are implemented—possibly in interaction with hardware components—with the aid of software that is executed on an electronics processor. Devices designed for radio communication usually have an antenna configuration for transmitting and receiving radio signals as part of a transceiver module. The electronic devices can also have an internal electrical power supply, which can be achieved, for example, with a replaceable or rechargeable battery. The devices can also be supplied wired, either by an external power supply or also by means of “Power over LAN”.

These and other aspects of the invention emerge from the figures discussed below.

### BRIEF DESCRIPTION OF THE FIGURES

The invention is explained in more detail below relating to the attached figures on the basis of exemplary embodiments, to which; however, the invention is not limited. Thereby, identical components in the various figures are provided with identical reference numbers. The figures schematically show:

FIG. 1 an application scenario of a computer-implemented method for triggering a function,

FIGS. 2-4 three data flow diagrams for the discussion of different aspects of the method according to the invention.

### DESCRIPTION OF THE EXEMPLARY EMBODIMENTS

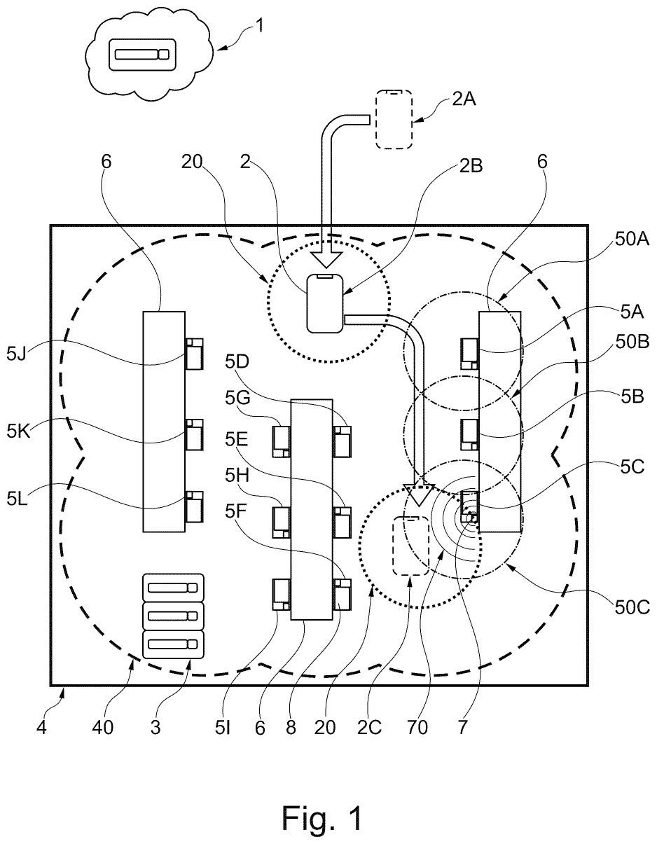

FIG. 1 shows the top view of a sales area 4, which occupies the interior of a supermarket. In the sales area 4, a WLAN radio network has been established in a known way due to the first radio device not shown, which spans across a WLAN radio range 40, which essentially covers the sales area 4. The first radio device to be used here are routers and/or WLAN access points, which are mounted to the ceiling of the sales area 4.

In the sales area 4 there are three shelves 6, which are shown from above. A plurality of electronic display units are attached to each shelf 6, which are designed as (in technical jargon) so-called “electronic shelf labels”, ESLs 5A to 5L for short. ESLs 5A to 5L are depicted dominantly on the front edges of shelves 6 to discuss the invention.

In the present case, the ESLs 5A to 5L are battery-operated and each have an energy-saving screen 8 (see ESL 5F, where this reference number is registered as a representative of all other ESLs) and a light-emitting diode (LED 7) (see ESL 5C, where this reference number is registered as a representative of all other ESLs).

The screen 8 can be implemented, in particular, as an electrophoretic screen by means of a generally known technology, marketed for example under the terms “electronic paper” or “E Ink” (which stands for electronic ink), and is provided (among other things) to provide product and/or price information on a product that corresponds to the relevant ESL 5A to 5L (not shown), which is located in the corresponding shelf 6 in the vicinity of the respective ESL 5A to 5L.

The LED 7 is designed to draw the attention of a person, in particular, a potential customer (but also, for example, an employee), to the corresponding ESL 5A to 5L and thus to the corresponding product. For this purpose, LED 7, which is designed to emit a human-perceptible light signal 70 in the visible wavelength range, such as a flashing red light for example, is controlled accordingly by the electronics (not shown) of the ESL 5A-5L.

In addition, the ESL 5A to 5L are designed for bidirectional communication via an ESL radio network, which is established in the sales area 4 via second radio devices (not shown). The embodiment of ESLs 5A to 5L can have a known transceiver tuned to the ESL radio network (not shown) with an antenna configuration for this purpose.

Routers and/or ESL access points, which are also attached to the ceiling of the sales area 4, are used as second radio device. They are operated in a different frequency band from the Wi-Fi wireless network to avoid interference. Optionally, they can also be operated in the same frequency band, wherein measures ensure that ESL-related radio traffic is not interfered with by Wi-Fi-related radio traffic.

For example, the well-known ZigBee protocol or the Bluetooth protocol or a proprietary protocol, such as that known from the WO 2015/124197 A1, can be used to implement the ESL wireless network. The product and/or price information for the ESLs 5A to 5L is provided via the ESL wireless network and transmitted to them and/or status information is requested from them.

For the control of radio traffic as well as for the control of internal signal and/or data processing and the control of the screen 8 as well as the LED 7, the ESLs 5A to 5L also have a processor unit, which is a component of the electronics of the ESLs 5A to 5L.

In this case, the ESL 5A to 5L are designed to communicate with the ESL access point via a Bluetooth protocol and therefore also receive Bluetooth beacon radio signals from other devices. In the present context, it is a mobile user device 2, for example a smartphone, which is designed to transmit the Bluetooth beacon radio signal as a Bluetooth beacon. The transmission of the Bluetooth beacon radio signal is symbolized by the circle 20.

Furthermore, a data processing system 3 is provided in the sales area 4, which manages and controls communication in the WLAN radio network as well as in the ESL radio network and is trained to communicate with devices within radio range 40 via the WLAN radio network and with ESL 5A to 5L via the ELS radio network. In this case, communication via the WLAN radio network concerns devices that enter radio range 40 of the sales area 4 and are trained for corresponding radio communication. The permanently installed components of the WLAN wireless network (routers and/or WLAN access points) as well as the permanently installed components of the ESL wireless network (routers and/or ESL access points) are preferably connected to the data processing system 3 by a cable.

If, for example, a mobile user device 2 forming the device moves from a first position 2A outside the sales area 4 to a second position 2B within radio range 40 and subsequently within the sales area 4, radio-based communication can be established between mobile user device 2 and data processing system 3. Mobile user device 2 is a smartphone used by a user (not shown) who is a potential customer of the supermarket.

A shop application provided by the supermarket operator is installed on the mobile user device 2, which allows the user to request information about products, tag products for purchase and ultimately make and pay for purchases.

FIG. 1 also depicts a cloud-based computer 1 that is locally independent of the sales area 4, symbolizing an Internet search engine. The cloud-based computer 1 is trained or programmed to communicate via the Internet with the data processing system 3 and/or with the mobile user device 2, which will be discussed below.

The infrastructure discussed in FIG. 1 is used to determine the success of an advertisement, as described below. In this context, it should be assumed that the user of mobile user device 2 was presented with an advertisement for a product of the supermarket shown in FIG. 1 provided by the computer 1 on mobile user device 2 when he/she visited a website with the aid of his/her user device 2, wherein he/she was outside the sales area 4 at position 2A. In this process, representation data representing the advertising consumed by the user or the user device 2 was stored on the user device 2, for example, with the aid of so-called cookies.

The user then decided to visit the supermarket and moved the mobile user device 2 from the first position 2A to the second position 2B. So, he/she took his/her smartphone with him/her to the sales area 4 of the supermarket.

In the following, two exemplary embodiments are now demonstrated of how the method presented here can be used to trigger a function as a result of the mobile user device 2 entering the sales area 4 or the radio range 40.

In accordance with an exemplary embodiment, the function is triggered by means of the data processing system 3, as discussed below.

If mobile user device 2 enters radio range 40 of the sales area 4, mobile user device 2 is recognized by data processing system 3 because it logs into the Wi-Fi network and transmits its identification data. The shop application is run on the user device 2, which enables communication with the data processing system 3. With the aid of the shop application, the representation data are now transmitted to the data processing system 3 in addition to the identification data. However, it can also be provided that the identification data will only be transmitted to the data processing system 3 together with the representation data during the course of using the shop application.

The data processing system 3 checks the representation data to see whether they relate to a product offered in the sales area 4. In the present case, the advertisement concerns green socks offered in the sales area 4 on the right-hand shelf 6 and which are advertised with the ESL 5C because the ESL 5C is logically linked in a database hosted by computer system 3. The product and/or price information that corresponds to the advertised product is therefore displayed by the ESL 5C. After it has been established that the advertised product is located at the position of the ESL 5C, a function that corresponds to the representation data is automatically triggered, wherein, in the present case, route description data are generated by the data processing system 3 and transmitted by the data processing system 3 to the mobile user device 2, where, with the aid of the shop application, a human-perceptible route description is displayed on the screen of the mobile user device 2 which the user only has to follow in order to get to the green socks.

Subsequently, the data processing system 3 generates the first advertising success data, which confirms that the user to whom the advertisement was previously presented has now also entered the sales area 4 that corresponds to the advertisement. The first advertising success data are transmitted from the data processing system 3 to the computer 1 and identifies the sales area 4 (i.e., the shop) in which the advertising success was determined, the user in question or his/her user device 2 (e.g., by means of the identification data) and, where applicable, also the advertising that presumably justifies the advertising success (e.g., by means of the representation data). In the case of the computer 1, a conversion rate can then be generated, which indicates how many users to whom the advertising was presented this led to a visit to the supermarket, which can be used as a starting point for taking account of the provision of the advertising or for a billing that takes into account the advertising success that actually occurred.

Furthermore, the mobile user device 2 is instructed by the data processing system 3 (with the aid of the shop application) to transmit Bluetooth beacon radio signals.

In accordance with a first embodiment variant, the Bluetooth beacon radio signal can contain a control code. For example, the control code can be individually preset or pre-programmed in the system for each ESL 5A to 5L with the aid of the data processing system 3, i.e., it can be known individually to all ESLs 5A to 5L. In the simplest variant, the control code can also be given by the unique ESL identification code (e.g., the individual MAC address of the respective ESL 5A to 5L), which each ESL 5A to 5L knows itself so that no programming of each individual ESL 5A to 5L is necessary.

In accordance with the first embodiment variant, the ESLs 5A to 5L are trained to decode the control code received via Bluetooth beacon radio signal and to act on it when receiving the applicable/individual control code, i.e., to control the LED 7 when it is received.

If the user moves towards the corresponding ESL 5C together with the user device 2, wherein the user now knows/on which shelf 6 he/she has to look for the green socks, the LED 7 of the ESL 5C will only start to light up (flash) when the ESL 5C receives the Bluetooth beacon radio signal of the mobile user device 2 with the control code provided for it.

If the Bluetooth beacon radio signal is transmitted with a relatively limited transmission power, it cannot be received until the user device 2 is positioned relatively close to the ESL 5C in question. On the other hand, the entry of user device 2 into an area of the ESL 5C can also be determined by the fact that the RSSI (Received Signal Strength Indication) value for the received beacon radio signal is evaluated at the ESL 5C and the LED is only controlled for flashing when this value exceeds a certain threshold value, i.e., this threshold-value criterion occurs.

As soon as this “proximity”, which is characterized by the application of the threshold-value criterion, has occurred between the mobile user device 2 and the ESL 5C, which is the case, for example, at position 2C to which the mobile user device 2 has been moved from position 2B, this circumstance is communicated by the ESL 5C to the data processing system 3 and recognized there as a further advertising success. Subsequently, the data processing system 3 generates second advertising success data, which confirms that the user to whom the advertising was previously provided has now also taken the path to the advertised product within the sales area 4. In addition to the information mentioned in connection with the first advertising success data, the second advertising success data now also contain information regarding the occurrence of the aforementioned “proximity” and, as discussed in connection with the first advertising a success data, are transmitted to the computer 1 for further processing.

In accordance with a second embodiment variant, the Bluetooth beacon radio signal can contain a control code which, when received by the ESL 5C, triggers the flashing of the LED 7. In the present case, however, it is a control code that uniquely identifies the mobile user device 2. The control code can therefore be the unique code identifying the Bluetooth beacon, which is recognized when entering the WLAN radio network and is transmitted to the relevant ESL (in this case the ESL 5C) with the aid of the data processing system 3 depending on the representation data. However, the control system can also be the identification data captured when entering the WLAN radio network when the shop application is executed, which are transmitted to the relevant ESL (in this case the ESL 5C) with the aid of data processing system 3 depending on the representation data.

The captured control code is thus transmitted with the aid of the data processing system 3 to the ESL 5C that corresponds to the representation data so that only this ESL 5C reacts to the Bluetooth beacon radio signal of the mobile user device 2, whereas all other ESLs 5A, 5B, 5D to 5L, ignore the Bluetooth beacon radio signal of the mobile user device 2.

All other processes that lead to the delivery of the second advertising success data are carried out in the same way as described in accordance with the first embodiment variant. If a purchase of the advertised product is subsequently recognized by the data processing system 3, wherein the purchase is made directly at the ESL 5C, for example, via NFC communication (i.e., an NFC-based interaction), as discussed in the general description, or the purchase is made at a point-of-sale terminal, third-party advertising success data can be generated by the data processing system 3, which confirm that the user has previously been provided with the advertisement, purchased the product advertised by the advertisement. In addition to the information mentioned in connection with the first and/or second advertising success data, the third advertising success data now also contain information regarding the occurrence of a purchase and are transmitted to the computer 1 for further processing, as discussed in connection with the first and/or second advertising success data.

Even though the present exemplary embodiment discusses the occurrence of the first, second and third advertising success data in a temporal sequence of events, it should be mentioned at this point that these individual advertising success data can of course also occur independently of each other, i.e., in isolation and therefore not in the sequence described.

In accordance with another embodiment variant, the ESLs 5A to 5L can be equipped with Bluetooth beacons or their Bluetooth radio system can be designed to transmit a Bluetooth beacon radio signal. This is symbolized with the aid of the circles 50A to 50C. In this embodiment variant, the mobile user device 2 is designed to receive and evaluate the received Bluetooth beacon radio signals in order to determine that the proximity has occurred, which is to be qualified as an advertising success. In the present embodiment variant, this is made possible by the fact that, when entering the sales area 4, the Bluetooth beacon code identifying the relevant ESL (in this case the ESL 5C) is transmitted from the data processing system 3 to the mobile user device 2 so that an autonomous evaluation of the received Bluetooth beacon radio signals can take place there.

For the sake of completeness, it should be mentioned here that the data processing system 3 not only detects the pairing between the product and ESL 5A to 5L, but also the Bluetooth beacon code identifying the respective ESL 5A to 5L so that the product in question can first be retrieved via the representation data, the relevant ESL (ESL 5C) based on it and, based on this, the Bluetooth beacon code to be used and transferred to the mobile user device 2.

As soon as the proximity has been established in the case of mobile user device 2, it communicates this circumstance to data processing system 3, where all further processing steps are processed as discussed. In the case of mobile user device 2, the proximity is also established by the fact that a Bluetooth beacon radio signal is received which contains the Bluetooth beacon code previously obtained from the data processing system 3, which belongs to the ESL 5A to 5L (in the present case ESL 5C), which is paired with the product advertised by the advertisement.

Even though the preceding discussion focused on the fact that the entry of mobile user device 2 into a WLAN radio range of the first radio device is determined, it should be mentioned at this point that this is not absolutely necessary. Rather, in accordance with an optional embodiment, it can also be determined on a radio-based basis that the mobile user device 2 has entered a radio range of the second radio device provided for communication with the ESLs. The aspects discussed above also apply to this optional embodiment in an analogous manner. This can even be done without the Wi-Fi wireless network.

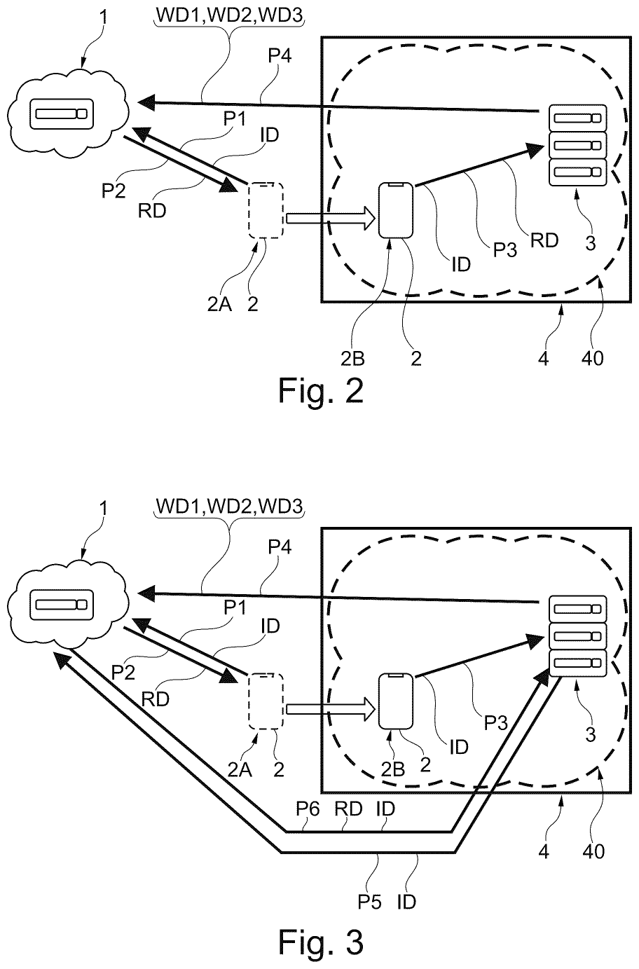

FIGS. 2 to 4 then discuss the basic concept of the invention by means of three data flow diagrams describing the data flow between the three entities, namely the computer 1, the mobile user device 2 and the data processing system 3.

FIG. 2 shows the computer 1 available via the Internet outside the sales area 4 and at position 2A the mobile user device 2 querying a web page, which is visualized by an arrow Pi, wherein the identification data ID of the mobile user device 2 is also transmitted to the computer 1. During the course of displaying the website, an advertisement is also transmitted from the computer 1 to the user device 2, which is visualized by an arrow P2. The advertising is represented by the representation data RD, which in the present case are also provided by the computer 1. However, the RD representation data can also be created directly on the mobile user device 2 on the basis of the advertising received and transmitted to the computer 1 linked to the ID identification data for traceability.

FIG. 2 also shows how mobile user device 2 is moved from position 2A to position 2B so that it is within the sales area 4, in particular, within the WLAN radio range 40. There, the identification data ID is transmitted from the mobile user device 2 to the data processing system 3. Equipped with this, the data processing system 3 checks via its connected WLAN radio network whether the mobile user device 2 identified by the identification data ID has the representation data RD on the basis of which the previously discussed generation of the first advertising success data WD1 is to take place, i.e., whether the advertising relates to the sales area 4 (shop/supermarket, etc.) in which the user device 2 is currently located. If this is the case, i.e., if the inspection yields a positive result, this is communicated by the data processing system 3 to the computer 1 in accordance with a fourth arrow P4.

In this context, it should be mentioned that the check can also be carried out without knowledge of the identification data ID or further processing of the identification data ID, if, for example, a completely anonymized result is to be obtained.

FIG. 3, in contrast to FIG. 2, shows that only the identification data ID are transmitted to the data processing system 3 from the mobile user device 3 located in the sales area 4. Equipped with this, the data processing system 3 checks by querying the computer 1, which is symbolized by an arrow P5 and wherein the identification data ID is transmitted to the computer 1, whether representation data RD belonging to the identification data ID are available in the computer 1. In the event that such representation data RD exists, they are transmitted together with the identification data ID in accordance with an arrow P6 from the computer 1 to the data processing system 3 and checked there whether the previously discussed generation of the first advertising success data WD1, i.e., whether the advertising concerns the sales area 4 (shop/supermarket, etc.) in which the user device 2 is currently located, according to which the method is to be followed as discussed in connection with FIG. 2.

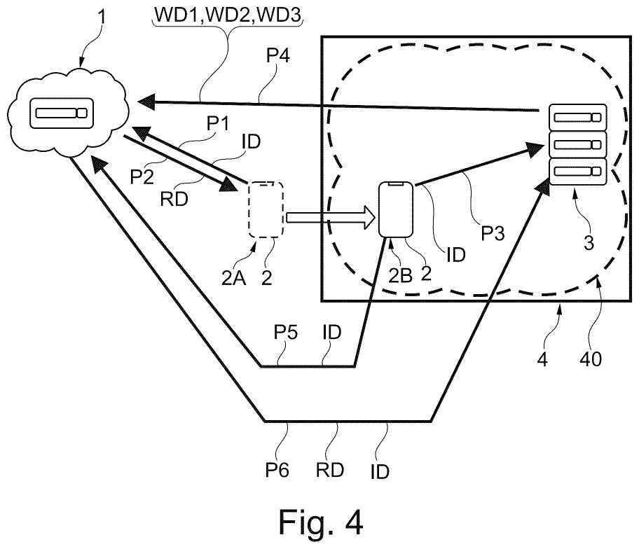

FIG. 4, in contrast to FIG. 3, shows that the mobile user device 2 that has entered the sales area 4 transmits its identification data ID (together with an ID that uniquely identifies the sales area 4 or its data processing system 3 in order to be able to address it from the computer 1) to the computer 1 in accordance with the arrow PS, whereupon the computer 1 transmits the representation data RD that correspond to the identification data ID to the data processing system 3 addressed with the aid of the ID together with the identification data ID in a data record in accordance with the arrow P6. Equipped with the identification data ID previously received from the mobile user device 2, the data processing system 3 checks whether a data record matching the mobile user device 2 has been obtained (identity of the identification data ID), on the basis of which the first advertising success data WD1 is to be generated, whereupon the method is to be followed as discussed in connection with FIG. 2.

Even though the data flow diagrams discussed above are limited to the first advertising success data WD1, it should be mentioned at this point that the same also applies to the second advertising success data WD2 and to the third advertising data WD3, which, depending on the implementation, can be generated within the sales area 4.

Ultimately, it should be mentioned at this point that the invention can also be applied to wired electronic display devices supplied with both communication technology and performance.

Ultimately, it is pointed out once again that the figures described in detail above are only exemplary embodiments, which can be modified by the person skilled in the art in various ways without leaving the scope of the invention. For the sake of completeness, it is also pointed out that the use of the indefinite article “a” does not exclude that the respective features can also be present a multiple of times.

1. Computer-implemented method for triggering a function, wherein the method comprises the following steps, namely:
determining in a radio-based manner that a mobile user device (2) is positioned at least in the vicinity of a sales area (4),
checking whether representation data (RD) are available representing advertising, in particular, relating to the sales area (4) and/or relating to a product offered, in particular, relating to the sales area (4), which advertising has been transmitted via the Internet to the user device (2) itself or to another device linked to the user device (2), and
automatically triggering of at least one function that corresponds to the representation data (RD).

2. The method according to claim 1, wherein, during the course of determining that the mobile user device (2) is positioned at least in the vicinity of the sales area (4), identification data (ID) are captured, which identification data (ID) identify the user device (2) or the user of the user device (2).

3. The method according to claim 1, wherein the automatic triggering of the function comprises at least one of the following activities, namely:
logging the proximity that has occurred,
automatically transmitting an electronic message to the mobile user device (2),
automatically transmitting an electronic message to a data processing system (3) assigned to the operator of the sales area (4),
wherein the logging and/or automatic transmission of the electronic message represents a single event of the proximity that has arisen or forms a representation of a plurality of such individual events.

4. The method according to claim 1, wherein the automatic triggering of at least one function that corresponds to the representation data (RD) entails that, on the basis of a database which stores the product position of products in the sales area (4) by means of product position data, the representation data (RD) are linked to the product position data for the product affected by the representation data (RD).

5. The method according to claim 1, wherein the automatic triggering of at least one function that corresponds to the representation data (RD) entails that a discount for the product advertised by the advertisement is automatically provided for automatic use.

6. The method according to claim 1, wherein the automatic triggering of at least one function that corresponds to the representation data (RD) entails that, as a result of the purchase of the product in the sales area, (4) purchase confirmation data are automatically generated, wherein the purchase confirmation data document a relationship between the advertisement and the purchased product, and the purchase confirmation data are made available for further processing.

7. The method according to claim 1, wherein radio-based determination is based on the fact that position data, which position data represent the position of the mobile user device (2), are received by radio from a computer (1) available via the Internet, and it is determined there that the mobile user device (2) is at least in the vicinity of the sales area (4), wherein the location of the sales area (4) is known to the computer (1); however, the computer (1) is not assigned to the sales area (4) or its operator.

8. The method according to claim 1, wherein the radio-based determination is based on the fact that the mobile user device (2) has entered a radio range (40; 50A-50C) which radio range (40; 50A-50C) is covered by radio device assigned to the sales area (4).

9. The method according to claim 2, wherein the captured identification data (ID) are transmitted to a data processing system (3) assigned to the sales area (4) or to the operator of the sales area

10. The method according to claim 9, wherein the data processing system (3) is used to check whether the representation data (RD) are present.

11. The method according claim 10, wherein the data processing system (3) contacts the user device (2) via the radio device for the purpose of checking whether the representation data (RD) are available and obtains the representation data (RD) from the user device (2) and further processes such representation data (RD).

12. The method according to claim 10, wherein the data processing system (3) initially receives a data record comprising the identification data (ID) and related representation data (RD) from a computer (1) distinct from the user device (2) or the other device linked to it, which is not assigned to the sales area (4) or its operator, and stores it for subsequent processing and as a consequence of the ascertained occurrence of the user device (2) into the radio range (40; 50A-50C) of the radio device checks whether a data record with the identification data (ID) that was also transmitted when the user device (2) entered the radio range (40; 50A-50C) has been stored, and, in the event of a positive test result, further processes the representation data (RD) of the data record.

13. The method according to claim 10, wherein the user device (2) communicates the entry into the radio range (40; 50A-50C) to a computer (1) which is not assigned to the sales area or its operator and which stores the representation data (RD) provided for the user device (2), in particular, via the Internet, and this computer (1) transmits a data record comprising the identification data (ID) and related representation data (RD), which belongs to the user device (2) communicating the entry into the radio range (40; 50A-50C) to the data processing device (3), and the data processing device (3) checks whether a data record with identical identification data (ID) has been received for the identification data (ID) of the user device (2) entering the radio range (40; 50A-50C), and, in the event of a positive test result, further processes the representation data (RD) of the data record.

14. The method according to claim 8, wherein the automatic triggering of the function is a human-perceptible reproduction/playback comprising one of the following forms of reproduction/playback, namely:
a light-signal reproduction,
a text reproduction,
an audio playback,—an image reproduction,
a video playback.

15. The method according to claim 14, wherein the content of the humanly perceptible representation is determined by the representation data (RD).

16. The method according to claim 14, wherein the human-perceptible reproduction/playback is triggered on the user device (2).

17. The method according to claim 14, wherein the human-perceptible reproduction/playback is triggered on an electronic display device (5A-5L), in particular, on an electronic shelf label, referred to as an “electronic shelf label”.

18. The method according to claim 17, wherein the automatic triggering of the human-perceptible reproduction/playback is selectively carried out only for those electronic display device(s) (5C) whose content is or is affected by the representation data (RD) or by the advertising represented by means of the representation data (RD).

19. The method according to claim 17, wherein the automatic triggering of the human-perceptible reproduction/playback is carried out depending on the position of the user device (2) in the sales area

20. The method according to claim 19, wherein a Bluetooth beacon is used to decide whether a distance threshold value between the electronic display device (5A-5C) and the user device (2) has been fallen short of, which serves as a criterion for triggering the human-perceptible reproduction/playback.

21. The method according to claim 20, wherein the electronic display device (5A-5C) comprises at least one LED (7) which is controlled for flashing light-signal reproduction.

22. The method according to claim 14, wherein the human-perceptible reproduction/playback is used for navigation to the position in the sales area provided for the product advertisement concerns.

23. The method according to claim 8, wherein after the mobile user device (2) has entered the radio range (40; 50A-50C) assigned to the sales area (4) is checked by the mobile user device (2) and/or by a data processing system (3) assigned to the sales area (4) whether the representation data (RD) is related to the sales area (4).

24. The method according to claim 23, wherein the reference to the sales area (4) is established by the fact that the representation data (RD) indicate the sales area (4) as advertised as such.

25. The method according to claim 23, wherein the reference to the sales area (4) is established by the fact that the representation data (RD) indicate a product offered in the sales area (4) as advertised.

26. The method according to claim 23, wherein the mobile user device (2) and/or the data processing system (3) generates advertising success data (WD1-WD3) if a reference to the sales area (4) is established.

27. The method according to claim 26, wherein the advertising success data (WD2) are generated when a distance between the mobile user device (2) and the advertised product determined on the basis of at least one radio signal has fallen below a distance threshold value.

28. The method according to claim 26, wherein the advertising success data (WD3) are generated if an electronic interaction has taken place between the mobile user device (2) and the electronic display device (5A-5L) assigned to the advertised product, or an interaction device, preferably an interaction concluding a purchase, in particular, the electronic interaction as a near-field communication (abbreviated NFC) interaction has taken place.

29. The method according to claim 26, wherein the advertising success data (WD1-WD3) are transmitted from the mobile user device (2) or the data processing system (3) to a computer (1) from which the advertisement was provided and which is not assigned to the sales area (4) or its operator.
